(19) United States
(12) Patent Application Publication
(10) Pub. No.: US 2012/0321118 A1
(43) Pub. Date: Dec. 20, 2012

(54) PORTABLE SPEAKER DEVICE

(75) Inventor: SUE CHENG, Chiayi County (TW)

(73) Assignee: MIPRO ELECTRONICS CO., LTD., Chiayi (TW)

(21) Appl. No.: 13/161,918

(22) Filed: Jun. 16, 2011

(51) Int. Cl. H04R 1/02

(52) U.S. Cl. 381/334

(57) ABSTRACT

A portable speaker device includes a cabinet shell body for receiving a speaker driver at a front tubular end thereof. A top wall of the cabinet shell body has a concavity defined by a recessed surface portion and front and rear inner surface portions. A handle lever is configured to be fitted into the concavity, and has a fulcrum region pivotally mounted to the rear inner surface portion, a weight region disposed proximate to the front inner surface portion to be angularly displaceable between laid-down and lifted positions, and a power region interposed and configured to facilitate gripping. A biasing member is disposed to bias the weight region to the laid-down position. A lift limiting member is disposed to limit the movement of the weight region to a predetermined distance when lifted toward the lifted position.

### BACKGROUND OF THE INVENTION

1. Field of the Invention

This invention relates to a portable speaker device, more particularly to a portable speaker device with a handle lever pivotably mounted on a top wall of a cabinet shell body.

2. Description of the Related Art

A conventional portable loudspeaker generally includes a handle projecting from a top wall of a cabinet shell body to facilitate carrying of the loudspeaker. The projecting handle is bulky and obtrusive, and is likely to collide with other objects and be damaged.

### SUMMARY OF THE INVENTION

An object of the present invention is to provide a portable speaker device which has a handle lever that can be concealed within a cabinet shell body.

According to this invention, the portable speaker device includes a cabinet shell body configured to enclose an accommodation chamber which extends forwardly to terminate at a front tubular end. The cabinet shell body has a top wall which extends rearwardly from the front tubular end in the longitudinal direction and which has an inner major surface to confront the accommodation chamber, and an outer major surface opposite to the inner major surface in an upright direction. The outer major surface has a concavity which extends toward the inner major surface to terminate at a recessed surface portion, and which further extends in the longitudinal direction to terminate at a front inner surface portion and a rear inner surface portion. A speaker driver has a basket frame fittingly mounted in the front tubular end, and a poleplate portion extending into the accommodation chamber. A handle lever is configured to be fitted into the concavity, and has a fulcrum region pivotably mounted to the rear inner surface portion about a fulcrum axis, a weight region disposed opposite to the fulcrum region, and proximate to the front inner surface portion and angularly displaceable relative to the recessed surface portion about the fulcrum axis between a laid-down position, where the weight region is closer to the recessed surface portion, and a lifted position, where the weight region is remote from the recessed surface portion, and a power region interposed between the fulcrum region and the weight region and proximate to the weight region for gripping by a user to lift the weight region toward the lifted position. A biasing member is disposed to bias the weight region toward the laid-down position. A lift limiting member is disposed to limit the movement of the weight region to a predetermined distance when the weight region is lifted toward the lifted position by a manual force against the biasing action of the biasing member.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of the preferred embodiment of a portable speaker device according to this invention;

FIG. 2 is a top view of the preferred embodiment;

FIG. 3 is a sectional view taken along line 3-3 of FIG. 2; and

FIG. 4 is a sectional view similar to FIG. 3 when a handle lever in a lifted state.

### DETAILED DESCRIPTION OF THE PREFERRED EMBODIMENT

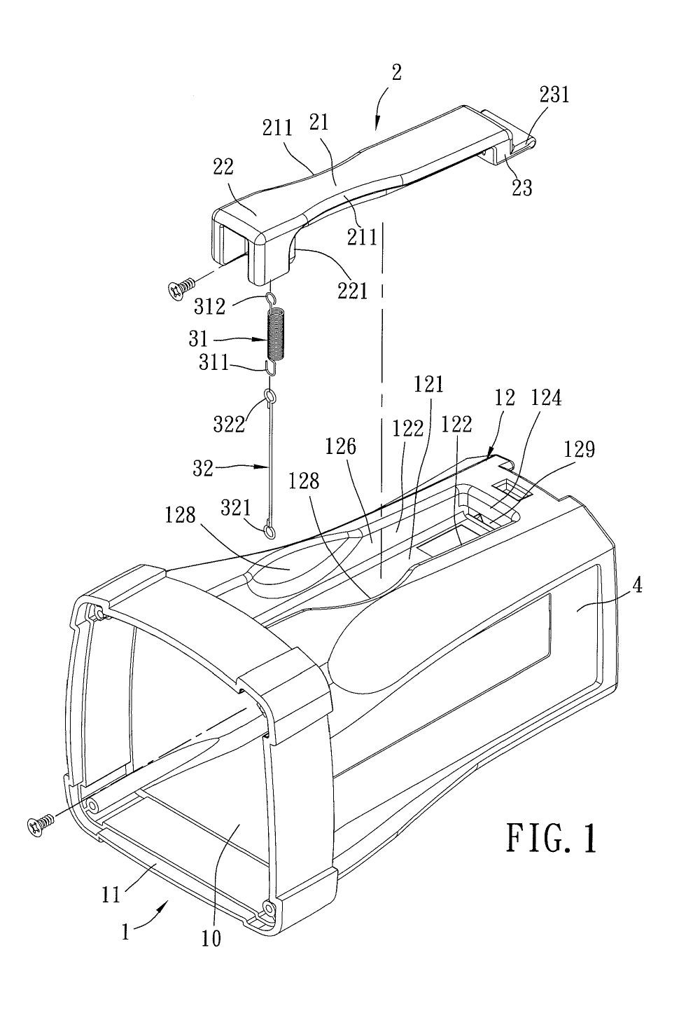

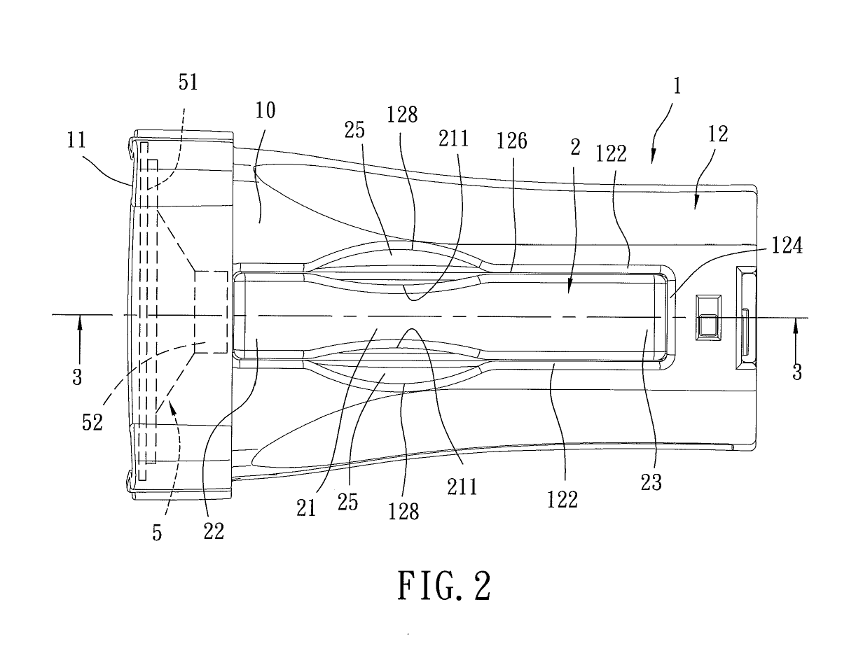

Referring to FIGS. 1 to 3, the preferred embodiment of a portable speaker device according to the present invention is shown to comprise a cabinet shell body 1, a speaker driver 5, an input panel 4, a handle lever 2, a biasing member 31, and a lift limiting member 32.

The cabinet shell body 1 is configured to enclose an accommodation chamber 10 which extends forwardly to terminate at a front tubular end 11. The cabinet shell body 1 has a top wall 12 which extends rearwardly from the front tubular end 11 in the longitudinal direction and which has an inner major surface (12a) to confront the accommodation chamber 10, and an outer major surface (12b) opposite to the inner major surface (12a) in an upright direction. The outer major surface (12b) has a concavity 126 which extends toward the inner major surface (12a) to terminate at a recessed surface portion 121, which extends in the longitudinal direction to terminate at a front inner surface portion 123 and a rear inner surface portion 124, and which extends in a transverse direction transverse to both the longitudinal direction and the upright direction to terminate at two side surface portions 122. The recessed surface portion 121 has a hole 127 disposed proximate to the front inner surface portion 123. The cabinet shell body 1 further has a suspending wall 125 which extends downwardly from the inner major surface (12a) and which is configured to suspend a mounting seat 120 from the inner major surface (12a). The mounting seat 120 is aligned with the hole 127. The rear inner surface portion 124 has an insertion hole 129. Further, two recessed areas 128 are formed in the side surface portions 122, respectively.

The speaker driver 5 has a basket frame 51 fittingly mounted in the front tubular end 11, and a poleplate portion 52 extending into the accommodation chamber 10.

The input panel 4 is mounted on the cabinet shell body 1.

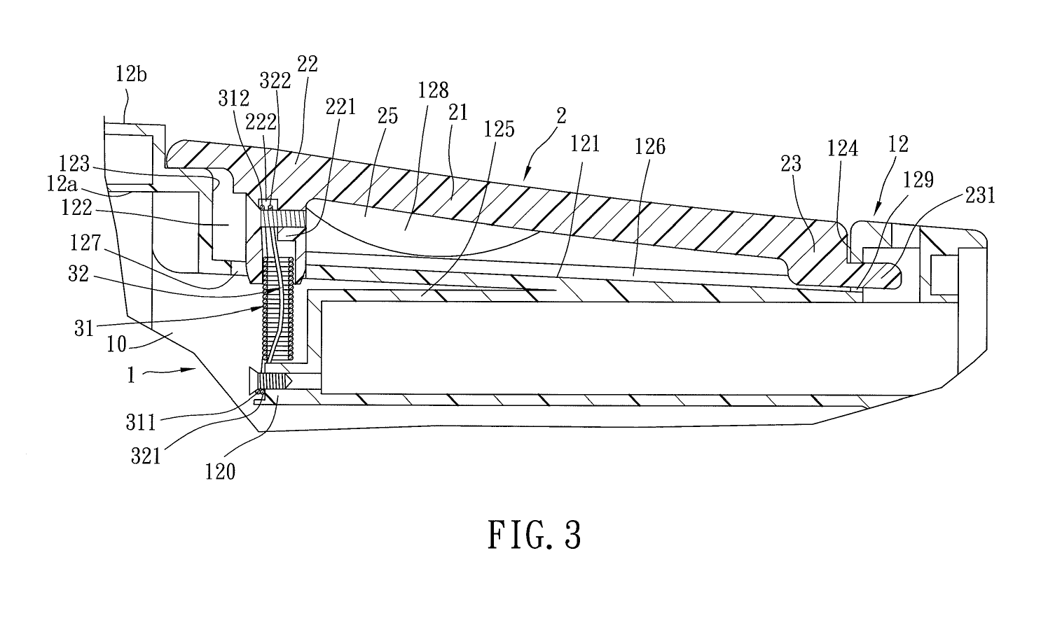

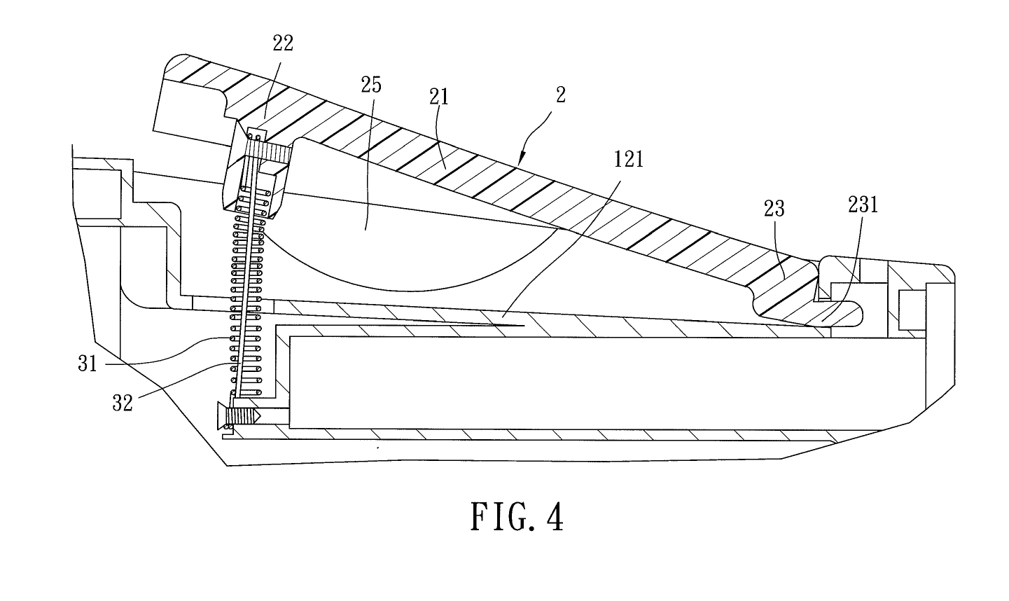

The handle lever 2 is configured to be fitted into the concavity 126, and has a fulcrum region 23, a weight region 22, and a power region 21. The fulcrum region 23 has a protrusion 231 which projects rearwardly and is configured to be inserted in the insertion hole 129 to be pivotably mounted to the rear inner surface portion 124 about a fulcrum axis. The weight region 22 is disposed opposite to the fulcrum region 23, and proximate to the front inner surface portion 123, and is angularly displaceable relative to the recessed surface portion 121 about the fulcrum axis between a laid-down position, as shown in FIG. 3, where the weight region 22 is closer to the recessed surface portion 121, and a lifted position, as shown in FIG. 4, where the weight region 22 is remote from the recessed surface portion 121. The power region 21 is interposed between the fulcrum region 23 and the weight region 22, and proximate to the weight region 22, and is formed with two narrow gripping areas 211 confronting and spaced apart from the recessed areas 128 in the transverse direction by gripping clearances 25 when the weight region 22 is in the laid-down position, thereby facilitating gripping by a user for lifting the weight region 22 toward the lifted position. Moreover, a tubular seat 221 is disposed to extend from the weight region 22, and defines a seat cavity 222 confronting the mounting seat 120.

The biasing member 31 is in the form of a coil spring 31, and has one end 311 anchored to the mounting seat 120, and the other end 312 securely received in the seat cavity 222 so as to bias the weight region 22 toward the laid-down position.

The lift limiting member 32 is in the form of a cord 32 which has one cord end 321 anchored to the mounting seat 120, and the other cord end 322 securely received in the seat cavity 222. The cord 32 has a predetermined length such that, as a result of lifting the weight region 22 by a manual force toward the lifted position, the cord 32 is tensed so as to hold the weight region 22 at the lifted position. Thus, the movement of the weight region 22 is limited to a predetermined distance (i.e., the predetermined length).

Accordingly, in use, the user can grip the power region 21 of the handle lever 2 and lift the weight region 22 to the lifted position for carrying the portable speaker device. Once the handle lever 2 is dropped off, the weight region 22 can be displaced to the laid-down position by the biasing action of the coil spring 31 so as to conceal the whole handle lever 2 within the concavity 126.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A portable speaker device comprising:
a cabinet shell body configured to enclose an accommodation chamber which extends forwardly to terminate at a front tubular end, said cabinet shell body having a top wall which extends rearwardly from said front tubular end in the longitudinal direction and which has an inner major surface to confront said accommodation chamber, and an outer major surface opposite to said inner major surface in an upright direction, said outer major surface having a concavity which extends toward said inner major surface to terminate at a recessed surface portion, and which further extends in the longitudinal direction to terminate at a front inner surface portion and a rear inner surface portion;
a speaker driver having a basket frame fittingly mounted in said front tubular end, and a poleplate portion extending into said accommodation chamber;
a handle lever configured to be fitted into said concavity, and having a fulcrum region which is pivotably mounted to said rear inner surface portion about a fulcrum axis, a weight region which is disposed opposite to said fulcrum region, and proximate to said front inner surface portion, and which is angularly displaceable relative to said recessed surface portion about the fulcrum axis between a laid-down position, where said weight region is closer to said recessed surface portion, and a lifted position, where said weight region is remote from said recessed surface portion, and a power region which is interposed between said fulcrum region and said weight region, and proximate to said weight region, and which is configured to facilitate gripping by a user for lifting said weight region toward the lifted position;
a biasing member disposed to bias said weight region toward the laid-down position; and
a lift limiting member disposed to limit the movement of said weight region to a predetermined distance when said weight region is lifted toward the lifted position by a manual force against the biasing action of said biasing member.

2. The portable speaker device according to claim 1, wherein said lift limiting member is a cord which has two cord ends connected to said weight region and under said recessed surface portion, respectively, and which has a length equal to the predetermined distance such that, as a result of lifting said weight region by the manual force toward the lifted position, said cord is tensed so as to hold said weight region at the lifted position.

3. The portable speaker device according to claim 2, wherein said biasing member is a coil spring which is disposed between said weight region and under said recessed surface portion.

4. The portable speaker device according to claim 3, wherein said recessed surface portion has a hole disposed proximate to said front inner surface portion for passage of said cord and said coil spring, said cabinet shell body having a mounting seat which is disposed under and suspended from said inner major surface, and which is aligned with said hole so as to anchor one of said cord ends and an end of said coil spring thereon.

5. The portable speaker device according to claim 4, wherein said cabinet shell body has a suspending wall which is configured to suspend said mounting seat, and which extends downwardly from said inner major surface.

6. The portable speaker device according to claim 5, wherein said handle lever has a tubular seat which is disposed to extend from said weight region, and which defines a seat cavity that confronts said mounting seat, and that is configured to securely receive the other one of said cord ends and the other end of said coil spring.

7. The portable speaker device according to claim 1, wherein said rear inner surface portion has an insertion hole, said fulcrum region having a protrusion which projects rearwardly and which is configured to be inserted in said insertion hole to permit angular displacement of said weight region about the fulcrum axis.

8. The portable speaker device according to claim 1, wherein said power region is formed with two narrow gripping areas to facilitate gripping.

9. The portable speaker device according to claim 6, wherein said top wall further has two recessed areas which are disposed to confront said narrow gripping areas, respectively, when said weight region is in the laid-down position in a direction transverse to both the longitudinal direction and the upright direction.
